(19) United States
(12) Patent Application Publication
(10) Pub. No.: US 2003/0031129 A1
(43) Pub. Date: Feb. 13, 2003

(54) Network packet flow admission control

(75) Inventor: Eryk Dutkiewicz, Figtree NSW (AU)

Correspondence Address: MOTOROLA, INC., 1303 EAST ALGONQUIN ROAD, IL01/3RD, SCHAUMBURG, IL, 60196

(73) Assignee: MOTOROLA, INC.

(21) Appl. No.: 09/879,542

(22) Filed: Jun. 12, 2001

(51) Int. Cl. H04L 12/26; H04L 12/56

(52) U.S. Cl. 370/230; 370/389

(57) ABSTRACT

A method (30) of packet flow admission control for a network with a shared communication medium. The method (30) is effected by receiving a packet flow request (31) including a requested transmission rate and a requested performance level. Steps of determining a total transmission rate (32) and maximum performance level (33) are followed by a step of identifying a maximum allowable transmission rate (34) associated with the maximum performance level and associated with a number of active nodes including currently active nodes and requesting node. A step of comparing (35) then compares the total transmission rate with the admission boundary and the flow request is admitted (36) in if the total transmission rate does not exceed the admission boundary.

### FIELD OF THE INVENTION

The present invention relates, in general, to admission control of data packet flows in a shared medium network. The invention is particularly useful for, but not necessarily limited to, admission control of data packet flows in a shared communication medium networks such as a wireless local area network (WLAN).

### BACKGROUND OF THE INVENTION

Typically, there are two main objectives for packet flow admission control in shared communication medium networks such as WLANs (which will be referred to in the rest of this specification by way of example only). As will be apparent to a person skilled in the art, a shared communication medium network is a network having nodes (computers or otherwise) that contend for a shared communication medium, or link, such as radio, wired or optical link. One of the main objectives of packet flow admission control is to ensure that only authorized users or nodes gain access to the WLAN. The other main objective is to ensure that packet flows admitted into the network obtain a requested level of performance from the WLAN. Until recently, the first objective has been predominant in local area networks (LANs) as existing services supported by the LANs do not require guaranteed or hard performance levels from the LANs. However, as WLANs are expected to support multimedia data that requires guaranteed performance levels, the second objective of admission control has become extremely important.

The decision regarding whether to admit a multimedia data packet flow into a WLAN, at a guaranteed level of performance, has been a challenging problem. The decision depends on many factors including the number of packet flows in the network, their characteristics, the number of active nodes in the network that handle these packet flows and the level of performance (e.g. minimum packet loss or allowable packet delay) required by the flows.

In wide area networks (WANs), admission boundaries have been used for determining packet flow mixes which the WANs can support at a guaranteed level of performance. An example of such admission boundaries for a simple network that supports two types of packet flows is shown in a graph 1 illustrated in FIG. 1. The two axes of the graph represent the two types of packet flows. Examples of packet flows are video data packet flows 4 and voice data packet flows 6. A line 8 on the graph 1 defines the admission boundaries for a mix of the two types of packet flows 4,6 requiring a common guaranteed level of performance. The line 8 divides the graph into two regions—an admission region 10 and a rejection region 12. A request for admission of a packet flow is acceded to if the overall flow mixes in the network fall in the admission region 10. Those skilled in the art know that the line 8 is typically concave due to characteristics of the packet flows and guaranteed performance levels required by the packet flows.

As is known in the art, flow-based admission boundaries used in WANs are not suitable for use in WLANs as they do not associate packet flows with any active transmitting nodes which compete for access to a common wireless channel in a WLAN. This association is, however, necessary in WLANs as the number of active nodes is an important parameter affecting performance.

### SUMMARY OF THE INVENTION

According to one aspect of the invention there is provided a method of packet flow admission control for a network with a shared communication medium, the method comprising:

receiving a packet flow request including a requested transmission rate and a requested performance level from a requesting node in the network;

determining a total transmission rate and maximum performance level, the total transmission rate includes transmission rates of currently active nodes in the network and the requested transmission rate, and the maximum performance level includes performance levels requested by the currently active nodes and the requested performance level;

identifying a maximum allowable transmission rate associated with the maximum performance level and a number of active nodes including the currently active nodes and the requesting node;

comparing the total transmission rate with the maximum allowable transmission rate; and

admitting the flow request in the network if the total transmission rate does not exceed the maximum allowable transmission rate.

According to another aspect of the invention there is provided a network with a shared communication medium, the network having a packet flow admission controller for effecting the steps of:

receiving a packet flow request including a requested transmission rate and a requested performance level from a requesting node in the network;

determining a total transmission rate and maximum performance level, the total transmission rate includes transmission rates of currently active nodes in the network and the requested transmission rate, and the maximum performance level includes performance levels requested by the currently active nodes and the requested performance level;

identifying a maximum allowable transmission rate associated with the maximum performance level and a number of active nodes including the currently active nodes and the requesting node;

comparing the total transmission rate with the maximum allowable transmission rate; and

admitting the flow request in the network if the total transmission rate does not exceed the maximum allowable transmission rate.

Suitably, the step of identifying can be effected by obtaining an admission boundary associated with the maximum performance level, wherein the admission boundary is used to identify the maximum allowable transmission rate.

Preferably, the maximum performance level can be an allowable packet loss ratio. The performance level may suitably be an allowable packet delay.

Preferably, the network can be a wireless local area network.

Suitably, the admission controller may be distributed on a plurality of nodes in the network. Alternatively, the admission controller may suitably resided on a single node in the network.

### BRIEF DESCRIPTION OF THE DRAWINGS

In order that the invention may be readily understood and put into practical effect, reference will now be made to a preferred embodiment as illustrated with reference to the accompanying drawings in which:

FIG. 1 is a graph showing admission boundaries in a prior art wide area network;

FIG. 2 is a schematic diagram showing a wireless local area network (WLAN) including several nodes, one of which functions as an admission controller;

FIG. 3 is a flowchart illustrating a method for packet flow admission control for the WLAN of FIG. 2;

FIG. 4 is a graph illustrating how admission boundaries for the WLAN of FIG. 2 are obtained in accordance with the invention;

FIG. 5 is a graph illustrating an example of how admission boundaries for the WLAN of FIG. 2 correspond to a lookup table;

FIG. 6 is a graph illustrating a simplified form of admission boundaries for the WLAN of FIG. 2; and

FIG. 7 is a graph illustrating a simplified form of admission boundaries for the WLAN of FIG. 2 in which example values are shown.

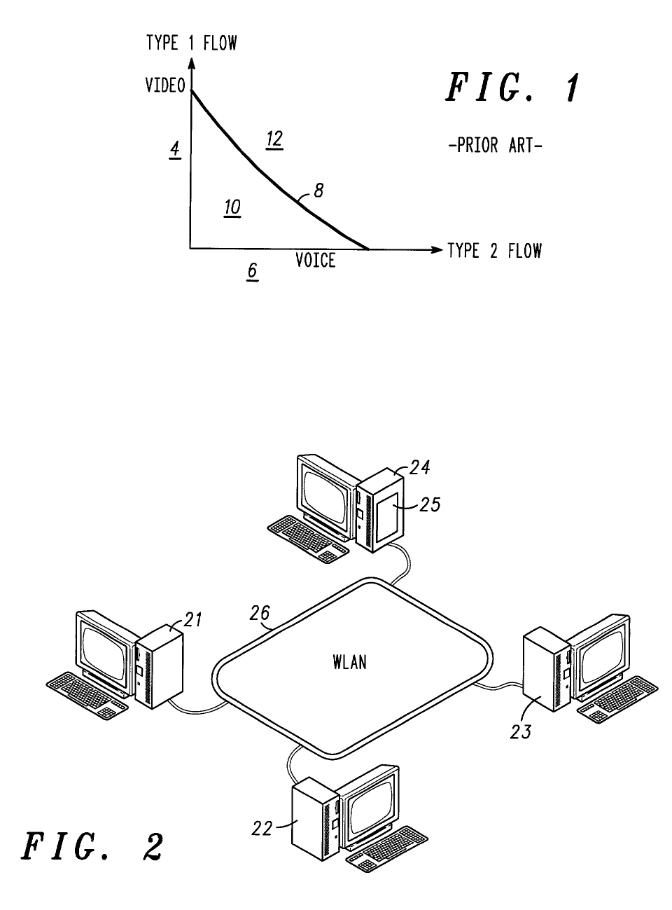

### DETAILED DESCRIPTION OF A PREFERRED EMBODIMENT OF THE INVENTION

Referring to FIG. 2, there is illustrated a plurality of nodes 21,22,23,24 (e.g. personal computers) in communication with each other through a WLAN 26. One of the nodes 24 performs a task of a centralized admission controller 25. Alternatively, the task of admission control may be distributed amongst more that one of the nodes 21,22,23,24. The admission controller 25 receives requests for admission of packet flows from the nodes 21,22,23,24. The requests can be made using any standardized signaling protocols known to those skilled in the art. An example of such a signaling protocol is described in an IETF Draft, and is included in this specification by reference, this draft is by R. Yavatkar et al. (R. Yavatkar, D. Hoffman, Y. Bernet, F. Baker and M. Speer) “SBM (Subnet Bandwidth Manager): A Protocol for RSVP-based Admission Control over IEEE 802-style networks”, Request for Comments: 2814 published in May 2000.

After receiving the requests, the admission controller 25 decides whether or not to admit or reject the packet flow requests based on available resources in the WLAN 26 at the time of the requests. The admission controller 25 keeps track of the available resources as packet flows are admitted and terminated in the WLAN 26.

The available resources are identified by reference to admission boundaries and will be described in more detail later.

Referring to FIG. 3 there is illustrated a method 30 of packet flow admission control for the WLAN 26 which is a network with a shared communication medium. The method 30 starts with a RECEIVE FLOW REQUEST step 31, where the admission controller 25 receives a packet flow request from one of the nodes 21,22,23,24, in the WLAN 26, that is requesting to send one or more packets to another node in the WLAN 26. The packet flow request includes a requested transmission rate and a requested performance level.

The method 30 next proceeds to a DETERMINE TOTAL TRANSMISSION RATE step 32, where the admission controller 25 determines a total transmission rate of the WLAN 26 if the request was to be accepted. The total transmission rate includes transmission rates of currently active nodes and the requested transmission rate of the requesting node. Active nodes are those that are transmitting a packet flow in the WLAN 26 immediately prior to the RECEIVE FLOW REQUEST step 31. As will be apparent to a person skilled in the art, an active node is a node which has current permission to send at least one packet flow into the network. A node that does not have permission to send any packet flows is inactive.

The method 30 then proceeds to a DETERMINE MAXIMUM PERFORMANCE LEVEL step 33 where the admission controller 25 determines a maximum performance level if the request was to be accepted and is based on performance levels of the currently active nodes and the requested performance level. This step can be effected by updating the maximum performance level each time a new packet flow request is received. The performance level may be specified in terms of packet losses or an allowable packet loss ratio, for example a 1% allowable packet loss ratio over a specified period of time. Alternatively, the performance level may be specified in terms of a tolerable delay.

The method 30 next proceeds to an OBTAIN ADMISSION BOUNDARY and IDENTIFY MAXIMUM ALLOWABLE TRANSMISSION RATES step 34 where, in one embodiment, the admission controller accesses a lookup table containing predetermined admission boundaries to obtain an admission boundary corresponding to the maximum performance level and a number of active nodes. The admission boundaries in the lookup table are obtained either through network simulations and/or measurements taken from an operational WLAN. An admission boundary separates an admission region from a rejection region. An admission region specifies active nodes transmission rates mixes which do not result in exceeding a particular performance level constraint. How these admission boundaries are obtained will be described in more detail later. Accordingly, the admission boundary identifies maximum allowable transmission rates for an associated maximum performance level. Alternatively, as discussed below, the maximum allowable transmission rates can be identified without firstly obtaining the admission boundary.

After the allowable transmission rate is identified, the admission controller compares the total transmission rate with the allowable transmission rate in a COMPARE TRANSMISSION RATE step 35. The admission controller 25 admits the packet flow request, at an ADMIT FLOW REQUEST step 36, if the total transmission rate does not exceed the allowable transmission rate. Alternatively, the flow request will be rejected by the admission controller 25 if the total transmission rate exceeds or is outside the allowable transmission rate.

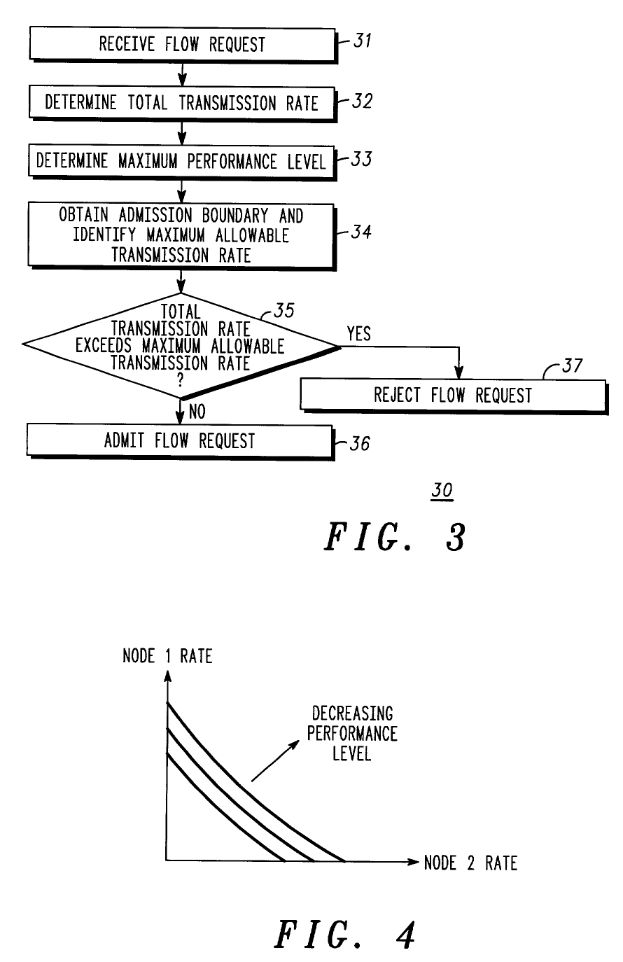

How the admission boundaries are obtained will be described next with the aid of FIG. 4 which shows a graph having lines that represent admission boundaries for a WLAN having two nodes for different guaranteed performance levels. The axes of the graph represent the transmission rates of the nodes respectively. The line closest to the origin of the graph represents admission boundaries for the most stringent performance level. Lines further away from the origin represent admission boundaries for less stringent performance levels.

Each one of the lines may be obtained by performing the following steps below:

a) Select a performance level, for example, an allowable packet loss ratio, for instance 1%.

b) Set the transmission rate of a first node to zero.

c) Increase the transmission rate of a second node until the packet loss reaches the allowable packet loss ratio (i.e. 1%).

d) Record and plot the above transmission rate on the graph.

e) Increase the transmission rate of the first node by a predetermined step.

f) With the transmission rate fixed, change the transmission rate of the second node until the packet loss ratio is attained. Record and plot the transmission rate on the graph.

g) Repeat steps e) and f), each time incrementing the transmission rate of the second node by a predetermined step until the transmission rate of the second node is zero.

h) Repeat the above steps for each performance level.

The lines are typically concave and symmetrical about an axis because the maximum transmission rate for each node is the same due to the fact that all nodes share the common wireless channel. The area under the concave line and the two axes represents the sum of transmission rates of the two nodes that can be supported by the WLAN.

The above steps may be repeated for a WLAN with three or more nodes. The transmission rates obtained in the above steps may be tabulated in lookup tables for use in OBTAIN ADMISSION BOUNDARY step 34. Below in table 1 is an example of such a lookup table for two active nodes. Further, referring to FIG. 5 there is illustrated an example of how entries in the first two columns (performance level of 1%) of the lookup table represent the corresponding admission boundary that identifies a maximum transmission rate boundary.

TABLE 1
Performance Level (e.g. % of packet loss)

| | | | |
|---|---|---|---|
| 1 | 2 | . . . | 10 |

| | | | | | | | |
|---|---|---|---|---|---|---|---|
| a_{1,1} | b_{1,1} | a_{1,2} | b_{1,2} | . | . | a_{1,10} | b_{1,10} |
| a_{2,1} | b_{2,1} | a_{2,2} | b_{2,2} | . | . | a_{2,10} | b_{2,10} |
| . | . | . | . | . | . | . | . |
| . | . | . | . | . | . | . | . |
| . | . | . | . | . | . | . | . |
| a_{n,1} | b_{n,1} | a_{n,2} | b_{n,2} | . | . | a_{n,10} | b_{n,10} |

Alternatively, instead of maintaining lookup tables with many entries that identify admission boundaries, the admission controller 25 may simply maintain a maximum transmission rate of the WLAN 26 for each number of active nodes and each performance level.

This maximum transmission rate is obtained by drawing a line tangential to each of the concave lines of, for example, the graph of FIG. 4. The tangential lines have a gradient of −1 because of the symmetry exhibited by the concave lines. The tangential lines are a linear approximation of the concave lines. It is thus easy to determine an admission boundary given these tangential lines.

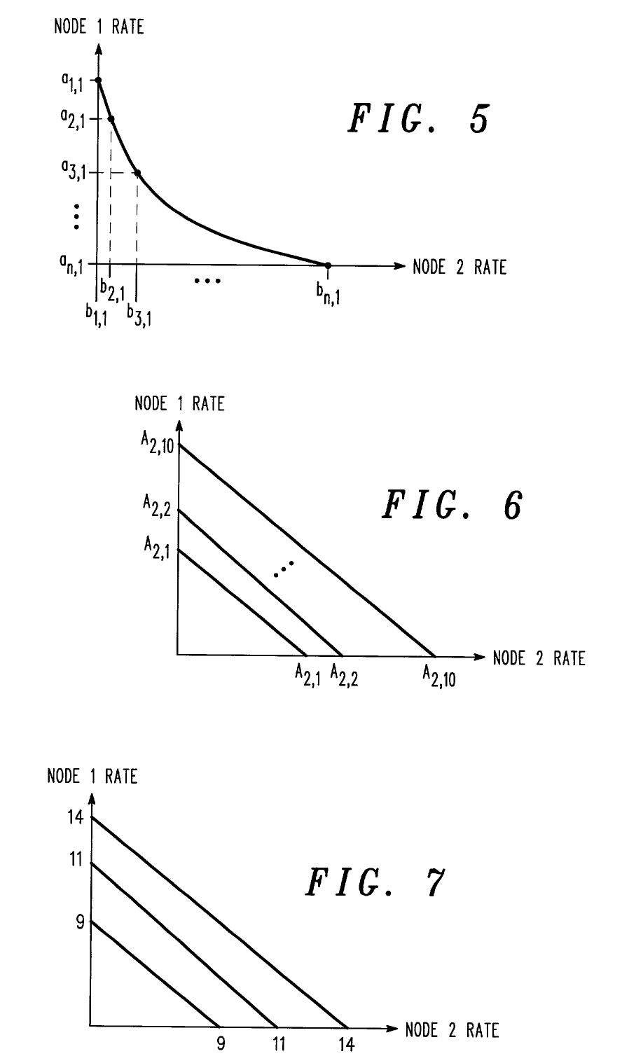

The resulting maximum transmission rates may be tabulated in a lookup table as shown below in table 2 for use in the method 30. FIG. 6 shows an example of how the entries in the second active node row in table 2 represent the corresponding admission boundaries for two active nodes.

TABLE 2

| | |
|---|---|
| Number of | |
| Active | Performance Level (e.g. % of packet loss) |

| Nodes | 1 | 2 | . . . | 10 |
|---|---|---|---|---|
| 1 | A_{1,1} | A_{1,2} | . | A_{1,10} |
| 2 | A_{2,1} | A_{2,2} | . | A_{2,10} |
| . | . | . | . | . |
| . | . | . | . | . |
| . | . | . | . | . |
| K | A_{k,1} | A_{k,2} | . | A_{k,10} |

The admission controller 25 keeps track of the number of active nodes and their respective transmission rates and the maximum performance level requested by the nodes. When a new flow requests admission into the network, the admission controller 25 determines the resulting number of active nodes and the resulting maximum performance level requested if this flow were admitted into the networks. The resulting number of active nodes and the resulting maximum performance level requested form the look-up table indices to determine the maximum transmission rate which can then be supported by the network. If the sum of the rates of the existing flows and the requested flow do not exceed this maximum transmission rate then the requested flow is accepted. Otherwise the requested flow is rejected.

Consider the following two numerical examples that illustrate how the most stringent performance level requirement determines the spare transmission rate capacity available in a network and how the admission controller 25 uses this information. The look-up table for the two examples is shown below in table 3 and FIG. 7 shows the admission boundaries for two active nodes based on table 3.

TABLE 3

| Number of | | | |
|---|---|---|---|
| Active | Performance Level (% of packet loss) | | |
| Nodes | 1 | 2 | 5 |
| 1 | 10 | 12 | 15 |
| 2 | 9 | 11 | 14 |
| 3 | 3 | 10 | 13 |

In the first example, assume that two active nodes are transmitting a packet flow of 2 Mbps each and that each flow requires a performance level of 2% packet loss. The spare capacity in the network at this performance level is 11−2−2=7 Mbps. Assume that a new flow request is next generated from one of the active nodes and that this request is for 4 Mbps and performance level of 1% packet loss. Since the performance level for this new flow request is now more stringent than that for the existing flows, the spare capacity at this performance level is 9−2−2=5 Mbps. This spare capacity is greater than that requested by the new flow request and hence the admission controller will admit this flow. The spare capacity after admitting the new flow will be 9−2−2−4=1 Mbps.

In the second example, assume that two active nodes are transmitting four packet flows of 1.5 Mbps each and that three flows require a performance level of 2% packet loss and one flow requires a performance level of 1%. The spare capacity in the network corresponds to the 1% performance level and is equal to 9−1.5−1.5−1.5−1.5=3 Mbps. Assume next that the flow with the performance level of 1% terminates. The spare capacity of the network now corresponds to the performance level of 2% packet loss and it is equal to 11−1.5−1.5−1.5=6.5 Mbps.

Advantageously, the invention allows for hard performance levels of admitted flows to be met. Further, admission boundaries are dependent on active nodes and therefore network utilization and performance can be improved.

Although the invention has been described with reference to a preferred embodiment, it is to be understood that the invention is not restricted to the embodiment described herein. For instance, the method is also applicable to wireline or optic networks which use random access contention mechanisms for accessing a common shared transmission medium.

We claim:

1. A method of packet flow admission control for a network with a shared communication medium, said method comprising:
receiving a packet flow request including a requested transmission rate and a requested performance level from a requesting node in said network;
determining a total transmission rate and maximum performance level, said total transmission rate includes transmission rates of currently active nodes in said network and said requested transmission rate, and said maximum performance level includes performance levels requested by said currently active nodes and said requested performance level;
identifying a maximum allowable transmission rate associated with said maximum performance level and a number of active nodes including said currently active nodes and said requesting node;
comparing said total transmission rate with said maximum allowable transmission rate; and
admitting said flow request in said network if said total transmission rate does not exceed said maximum allowable transmission rate.

2. A method according to claim 1, wherein said step of identifying is effected by obtaining an admission boundary associated with said maximum performance level, wherein said admission boundary is used to identify said maximum allowable transmission rate.

3. A method according to claim 1, wherein said maximum performance level is an allowable packet loss ratio.

4. A method according to claim 1, wherein said performance level is an allowable packet delay.

5. A method according to claim 1, wherein said network is a wireless local area network.

6. A method according to claim 1, wherein said method is effected by an admission controller distributed on a plurality of nodes in said network.

7. A method according to claim 1, wherein said method is effected by an admission controller residing on a single node in said network.

8. A network with a shared communication medium, said network having a packet flow admission controller for effecting the steps of:
receiving a packet flow request including a requested transmission rate and a requested performance level from a requesting node in said network;
determining a total transmission rate and maximum performance level, said total transmission rate includes transmission rates of currently active nodes in said network and said requested transmission rate, and said maximum performance level includes performance levels requested by said currently active nodes and said requested performance level;
identifying a maximum allowable transmission rate associated with said maximum performance level and a number of active nodes including said currently active nodes and said requesting node;
comparing said total transmission rate with said maximum allowable transmission rate; and
admitting said flow request in said network if said total transmission rate does not exceed said maximum allowable transmission rate.

9. A network according to claim 8, wherein said step of identifying is effected by obtaining an admission boundary associated with said maximum performance level, wherein said admission boundary is used to identify said maximum allowable transmission rate.

10. A network according to claim 8, wherein said maximum performance level is an allowable packet loss ratio.

11. A network according to claim 8, wherein said performance level is an allowable packet delay.

12. A network according to claim 8, wherein said network is a wireless local area network.

13. A network according to claim 8, wherein said admission controller is distributed on a plurality of nodes in said network.

14. A method according to claim 8, wherein said admission controller resides on a single node in said network.
